(19) United States
(12) Patent Application Publication
(10) Pub. No.: US 2026/0206002 A1
(43) Pub. Date: Jul. 16, 2026

(54) SYSTEM AND METHOD FOR TRANSMITTING POSITIONING DATA USED TO IDENTIFY SPATIAL LOCATION INFORMATION OF LIGHT-EMITTING DEVICES IN REAL TIME

(71) Applicant: CALVINLAB, INC., Gyeonggi-do (KR)

(72) Inventor: Sung Su KIM, Seoul (KR)

(21) Appl. No.: 19/054,923

(22) Filed: Feb. 17, 2025

(30) Foreign Application Priority Data
Jan. 10, 2025 (KR) 10-2025-0004398

(51) Int. Cl. H04W 64/00; G01S 5/16

(52) U.S. Cl. CPC H04W 64/006; G01S 5/16

(57) ABSTRACT

A system and a method for transmitting positioning data used to identify spatial location information of light-emitting devices are disclosed.

A system for transmitting positioning data used to identify spatial location information of light-emitting devices within a performance venue in a system for transmitting and receiving positioning data including the system for transmitting positioning data and a plurality of light-emitting devices according to one aspect includes a master console configured to generate positioning data to enable each of the plurality of light-emitting devices to identify its spatial location information on its own, a directional beam projector configured to project a directional beam onto at least one target light-emitting device to identify its spatial location information among the plurality of light-emitting devices, and a positioning signal broadcaster configured to broadcast a positioning signal modulated to include the positioning data to the plurality of light-emitting devices within the performance venue.

By utilizing the present disclosure, it is possible to implement a system and a method for transmitting positioning data used to identify spatial location information of light-emitting devices to a plurality of light-emitting devices within an event space, so that location information within the event space may be identified by individual light-emitting devices.

### CROSS-REFERENCE TO RELATED PATENT APPLICATION

The present application claims priority under 35 U.S.C. § 119 (a) to Korean patent application number 10-2024-0004398 filed on Jan. 10, 2025, in the Korean Intellectual Property Office, the entire disclosure of which is incorporated by reference herein.

### BACKGROUND OF THE INVENTION

### 1. Field

The present disclosure relates to a system and method for transmitting positioning data used to identify spatial location information of light-emitting devices in real time. More specifically, the present disclosure relates to a system and method for transmitting positioning data used to identify spatial location information of light-emitting devices to a plurality of light-emitting devices within an event space, such as performance venue, sports stadium, large-scale event, or exhibition hall, so that each light-emitting device (e.g., a “cheer stick”) may identify location information (e.g., a seat number or a zone number in a standing zone, hereinafter referred to as “spatial location information”) within the event space of each participant carrying a light-emitting device on its own.

### 2. Description of the Related Art

The present disclosure relates to a technology that allows a director to generate various lighting patterns, i.e., formations, in real time at a performance venue and transmit them to individual light-emitting devices (e.g., cheer sticks) to execute lighting effects.

Formation is a concept similar to Light Plot, which refers to the lighting layout design in conventional performance lighting, and involves grouping the coordinates of the light-emitting devices carried by individual participants in the performance venue into specific shapes or patterns, allowing them to be controlled as a single lighting device.

The inventor of the present disclosure has proposed “Real-Time Dynamic Cluster Control System and Method” in Korean Patent Application No. 10-2024-0068851, which generates formation data in real time at a performance site and transmits the same wirelessly, allowing a plurality of light-emitting devices to simultaneously implement lighting effects. Unlike conventional light-emitting device control technology that required prepared data to be stored in light-emitting devices in advance before the performance, this is a technology that allows formation data to be generated in real time during the event and transmitted collectively to the light-emitting devices within the event space. As a result, there is an advantage in that the formation of lighting effects using light-emitting devices (e.g., cheer sticks) in the event space may be modified and added in real time according to the on-site atmosphere and situation.

However, this technology for controlling a plurality of light-emitting devices had the inconvenience of requiring each participant to carry a smart device for inputting spatial location information of each light-emitting device (e.g., a smartphone in which an app related to control of the light-emitting device is installed).

Therefore, a method was needed to enable light-emitting devices to identify spatial location information without each participant making the effort to input the spatial location information of each light-emitting device using a separate smart device.

Furthermore, in generating formation data before the start of a performance and transmitting it to light-emitting devices, a method of enabling each light-emitting device to identify spatial location information on its own was still needed for effective performance production.

### PRIOR-ART DOCUMENT

### Patent Document

Korean Patent Application No. 10-2024-0068851

### SUMMARY OF THE INVENTION

The present disclosure was derived in response to the above-mentioned needs and aims to provide a system and method for transmitting positioning data used to identify spatial location information of light-emitting devices to a plurality of light-emitting devices within an event space, such as a performance venue, sports stadium, large-scale event, or exhibition hall, so that each light-emitting device may identify location information within the event space of each participant carrying the light-emitting device on its own.

To achieve the aforementioned objective, a system for transmitting positioning data used to identify spatial location information of light-emitting devices within a performance venue in a system for transmitting and receiving positioning data including the system for transmitting positioning data and a plurality of light-emitting devices according to one aspect, includes: a master console configured to generate positioning data to enable each of the plurality of light-emitting devices to identify its spatial location information on its own; a directional beam projector configured to project a directional beam onto at least one target light-emitting device to identify its spatial location information among the plurality of light-emitting devices; and a positioning signal broadcaster configured to broadcast a positioning signal modulated to include the positioning data to the plurality of light-emitting devices within the performance venue.

Here, the master console may further include a data manager configured to generate and store the positioning data for the at least one target light-emitting device in each sequence based on seat map data of the performance venue and spatial location information of each object within the performance venue, a directional beam controller configured to generate a directional beam control signal to control an operation of the directional beam projector, and a positioning signal broadcaster controller configured to generate a positioning signal broadcaster control signal to control the positioning signal broadcaster.

Additionally, the object may include at least individual seats disposed in the performance venue, the directional beam projector, and the positioning signal broadcaster.

Additionally, the directional beam controller may be configured to transmit a trigger signal to initiate a spatial location information identification process of the target light-emitting device to the directional beam projector.

Additionally, the positioning signal broadcaster controller may be configured to transmit the positioning data to the positioning signal broadcaster in each sequence and control the positioning signal to be transmitted in a sequence synchronized with the directional beam.

Additionally, the positioning signal may be a radio frequency signal.

Further, the directional beam projector may further include a beam modulator configured to modulate a directional beam based on a trigger signal transmitted from the directional beam controller, a light source configured to emit the directional beam modulated by the beam modulator based on the trigger signal, and an optical system configured to adjust optical characteristics of the directional beam emitted by the light source.

Furthermore, the directional beam projector may further include a communication interface configured to receive the trigger signal, a directional beam modulation signal, and a directional beam control signal from the master console.

Additionally, the directional beam projector may further include a directional beam actuator configured to move a projection area of the directional beam.

Additionally, the directional beam may be a directional infrared beam.

Additionally, the positioning data may include, as positioning data elements constituting the positioning data, at least one of spatial location information of the directional beam projector, a projection angle of the directional beam, a beam projection distance from the directional beam projector to the target light-emitting device, an intensity of the directional beam, an arrival time of the directional beam, and a unique identification value of the directional beam projector.

Additionally, the positioning data may include at least one positioning data element in a specific sequence.

According to another aspect, a method of transmitting positioning data used to identify spatial location information of light-emitting devices within a performance venue in a system for transmitting positioning data including a master console, a directional beam projector, and a positioning signal broadcaster, the method may include: generating positioning data to enable at least one target light-emitting device to identify its spatial location information on its own by the master console; generating a directional beam control signal for a target projection area of a directional beam by the master console; transmitting the positioning data to the positioning signal broadcaster in each sequence and generating a positioning signal broadcaster control signal to control the positioning signal broadcaster by the master console; projecting the directional beam onto the target projection area based on the directional beam control signal by the directional beam projector; and by the positioning signal broadcaster, generating a positioning signal modulated to include the positioning data, and broadcasting the positioning signal within the performance venue to be transmitted in a sequence synchronized with the directional beam, based on the positioning signal broadcaster control signal.

Here, the positioning data may be generated in each sequence based on seat map data of the performance venue and spatial location information of each object within the performance venue.

Further, the projecting of the directional beam onto the target projection area may further include generating, by the directional beam projector, a modulated infrared beam including a trigger signal for initiating spatial location information identification of the target light-emitting device based on the directional beam control signal, and adjusting optical characteristics of the infrared beam by the directional beam projector, based on the directional beam control signal, so that the infrared beam has directionality.

Furthermore, the projecting of the directional beam onto the target projection area may further include moving a projection area of the directional beam by the directional beam projector, based on the directional beam control signal.

Additionally, in generating the positioning data to enable the at least one target light-emitting device to identify its spatial location information on its own by the master console, if a spatial location calculation algorithm of the light-emitting device identifies spatial location information by receiving spatial location information of a specific object and comparing times of reception, the positioning data may include the spatial location information of the specific object as a positioning data element.

Alternatively, in generating the positioning data to enable the at least one target light-emitting device to identify its spatial location information on its own by the master console, if a spatial location calculation algorithm of the light-emitting device identifies spatial location information by performing a trigonometric function-based computation on spatial location information and projection angle data of two directional beam projectors, the positioning data may include first spatial location information and a first projection angle of a first directional beam projector, and second spatial location information and a second projection angle of a second directional beam projector as positioning data elements.

Alternatively, in generating the positioning data to enable the at least one target light-emitting device to identify its spatial location information on its own by the master console, if a spatial location calculation algorithm of the light-emitting device identifies spatial location information by performing a trigonometric function-based computation on a directional beam projection distance and a projection angle data from the directional beam projector, the positioning data may include a distance between the directional beam projector and the light-emitting device and a projection angle of the directional beam projector as positioning data elements.

By utilizing the present disclosure, it is possible to implement a system and method for transmitting positioning data used to identify spatial location information of light-emitting devices to a plurality of light-emitting devices within an event space, such as a performance venue, sports stadium, large-scale event, or exhibition hall, so that location information within the event space of each participant carrying a light-emitting device may be identified by individual light-emitting devices.

Furthermore, since the spatial location information within the event space of each participant carrying a light-emitting device is identified by individual light-emitting devices on its own, the blinking of the light-emitting devices may be controlled individually or in groups based on this information.

### BRIEF DESCRIPTION OF THE DRAWINGS

FIG. 1 is a diagram illustrating an example of a system for transmitting positioning data used to identify spatial location information of light-emitting devices.

FIG. 2 is a block diagram illustrating a master console of the system for transmitting positioning data.

FIG. 3 is a diagram illustrating an example of a directional beam projector of the system for transmitting positioning data.

FIG. 4 is a diagram illustrating an example of a method of transmitting positioning data used to identify spatial location information of light-emitting devices within a performance venue.

FIG. 5 is a diagram illustrating an example of a light-emitting device.

FIGS. 6A and 6B are diagrams illustrating a first algorithm, which is a spatial location calculation algorithm for a technique in which a light-emitting device within a performance venue receives spatial location information of a specific object and identifies the spatial location information by comparing times of reception.

FIGS. 7A and 7B are diagrams illustrating a second algorithm, which is a spatial location calculation algorithm for a technique in which a light-emitting device receives spatial location information and projection angle data of a directional beam projector and identifies spatial location information by performing a trigonometric function-based computation on these positioning data elements.

FIG. 8 is a diagram illustrating a third algorithm, which is a spatial location calculation algorithm for a technique in which a light-emitting device receives directional beam projection distance and projection angle data from a directional beam projector and identifies spatial location information by performing a trigonometric function-based computation on these positioning data elements.

### DETAILED DESCRIPTION

Hereinafter, embodiments of a system and method for transmitting positioning data used to identify spatial location information of light-emitting devices in real time will be described in more detail with reference to the drawings.

Throughout the specification and drawings, unless otherwise stated, each term is defined as follows.

### Performance Venue

It broadly includes an event space, such as a music performance venue, sports stadium, large-scale event, or exhibition hall (hereinafter referred to as “performance venue”), which is organized with clearly separated seats, zones, or specific areas.

### Participant (Audience)

“Participant” means a person carrying a light-emitting device assigned to him/her within the performance venue.

### Participant Location

“Participant location” refers to the physical space actually occupied by each participant within the performance venue. This includes a designated seat, a specific point in the standing zone, or other clearly identifiable spatial location of the participant, and represents the actual point where the light-emitting device held by the participant is located.

### Participant Location Information

“Participant Location Information” means a unique identifier or marker used to identify and distinguish the location of each participant within the performance venue. It may be expressed in the form of seat numbers, zone identifiers, row and column combinations, and location indications within standing zones. Throughout the specification and drawings, participant location information has the same meaning as the location information of the light-emitting device assigned to that participant, unless otherwise stated.

### Spatial Location Information

Inside the performance venue, objects such as individual seats, directional beam projectors, positioning signal broadcasters, master systems, and light-emitting devices are disposed.

The spatial location information refers to information that indicates the physical location that each object within the performance venue actually occupies within the actual space of the performance venue.

For example, a unique coordinate value within a coordinate system defined for the performance venue, which is assigned to a seat with a specific seat number within the performance venue, may be spatial location information for that seat.

Therefore, the spatial location information may be used as information indicating the physical location of each participant (or a light-emitting device assigned to a participant) within the performance venue.

The spatial location information broadly includes the data types exemplified in Table 1 below, but is not limited thereto.

TABLE 1
1. Numerical coordinate values using a two-dimensional or three-
dimensional coordinate system
2. An identifier that indicates a designated zone or section within a
performance venue
3. Relative distance and direction from a specific reference point
4. Location code based on grid system
5. Angle and distance information using a polar coordinate system
6. Vector representation in three-dimensional space
7. Description of relative location based on major landmarks within the
performance venue
8. Traditional seat numbering system
9. Relative location expressed as a percentage of the size of the
performance venue
10. Location data obtained through various technologies such as depth
sensors, RFID, Bluetooth beacons, and acoustic-based positioning

The spatial location information may be expressed in a single form or used in a combination of multiple forms, and may be selected or converted into the most appropriate form according to the structure of the performance venue, purpose of use, and technical requirements.

In addition, the spatial location information is utilized to accurately determine the location of light-emitting devices, group them, and control them individually, enabling diverse and sophisticated performance productions.

### Positioning Data

Positioning data refers to any data necessary to identify the spatial location information of an object (e.g., a light-emitting device) within the performance venue. “Identifying” spatial location information broadly includes deriving a result value by performing a calculation using established rules and algorithms, confirming given spatial location information, and determining a specific value as spatial location information through approximate calculation and/or inference.

The positioning data may be transmitted to each light-emitting device via transmitter within the performance venue. The positioning data may include spatial reference information. Additionally, the positioning data may include transmitter-related parameters, i.e., directional beam projector-related parameters and positioning signal broadcaster-related parameters. Furthermore, the positioning data may include other additional information used to identify spatial location information.

Spatial reference information may include the following positioning data elements:

Spatial location information itself for a specific location (e.g., coordinate
data, etc.)
Spatial location information of reference points within performance
venue
Information about structure and seating layout of performance venue
Location data of major landmarks within performance venue
Spatial location information
Information about logical structure of performance venue (e.g., grid
system and zone divisions)

Transmitter-related parameters may include the following positioning data elements:

Spatial location information of infrared (IR) transmitter (e.g., coordinate
data of IR transmitter)
Beam projection angle of IR transmitter
Beam projection distance between IR transmitter and specific light-
emitting device
IR signal strength
IR beam projection duration
When a plurality of IR transmitters are used, unique identification
information and related data for each IR transmitter

Additional information may include the following positioning data elements:

Correction coefficient required for calculations performed by a light-
emitting device to identify its own spatial location information
Positioning algorithm parameters
Information required for calculations and/or corrections performed by
other light-emitting device to identify its own spatial location information

In other words, positioning data, which is the data necessary for a light-emitting device to identify its own spatial location information, specifically includes positioning data elements as shown in Table 2 below.

TABLE 2

| Positioning | |
|---|---|
| Data Type | Positioning Data Elements |
| Spatial | Spatial location information itself for a specific |
| reference | location (e.g., coordinate data) |
| information | Location data of reference points within |
| | performance venue |
| | Information about structure and seating layout of |
| | performance venue |
| | Spatial location information of major landmarks |
| | within performance venue |
| | Information about logical structure of performance |
| | venue (e.g., grid system and zone divisions) |
| Transmitter | Spatial location information of IR transmitter (e.g., |
| related | coordinate data of IR transmitter) |
| parameters | Beam projection angle of IR transmitter |
| | Beam projection distance from the IR transmitter |
| | (i.e., beam projection distance between IR |
| | transmitter and specific light-emitting device) |
| | IR signal strength |
| | Arrival time of IR signal |
| | When a plurality of IR transmitters are used, unique |
| | identification information and related data for each |
| | IR transmitter |
| Other | Correction coefficient required for calculations |
| additional | performed by a light-emitting device to identify its |
| information | own spatial location information |
| | Positioning algorithm parameters |
| | Information required for calculations and/or |
| | corrections performed by other light-emitting device |
| | to identify its own spatial location information |

The positioning data may be data including only one positioning data element or may be data including a plurality of positioning data elements, according to various needs such as the computational algorithm (“spatial location calculation algorithm”) used to identify spatial location information, the characteristics of the performance venue, and the required accuracy.

The positioning data is used by a light-emitting device within the performance venue that receives a directional beam (e.g., a directional infrared beam) and a positioning signal (e.g., a positioning RF signal) from the system for transmitting positioning data to identify its own spatial location information.

More specifically, when a directional infrared beam is projected onto a specific light-emitting device within the performance venue, the light-emitting device initiates a process for identifying its own spatial location information by a trigger signal included in the directional infrared beam. In other words, the light-emitting device demodulates the broadcasted positioning signal, extracts the positioning data of a corresponding sequence, and then performs computations according to a predetermined spatial location calculation algorithm based on the positioning data, thereby identifying its own spatial location information.

In other words, unlike conventional technologies, even if the light-emitting device is not provided with spatial location information by an external device (e.g., a smartphone of each participant with an app for setting the light-emitting device installed) or a preset operation for each light-emitting device, the light-emitting device according to the present disclosure enables it to identify spatial location information on its own in real time.

### Spatial Location Calculation Algorithm

Spatial location calculation algorithm is a term that refers to a calculation method used by a light-emitting device to identify its own spatial location information using positioning data.

The spatial location calculation algorithm is embedded in the data storage device (e.g., memory) of each light-emitting device.

The spatial location calculation algorithm may select an appropriate method or combine multiple methods according to the characteristics of the performance venue, the type of transmitters used, and the required accuracy.

For each light-emitting device, a number of calculation algorithms may be prepared in advance to meet various needs such as the characteristics of the performance venue, the type of transmitter used, and the required accuracy, and the light-emitting device may identify spatial location information by appropriately selecting or combining spatial location calculation algorithms that meet the needs.

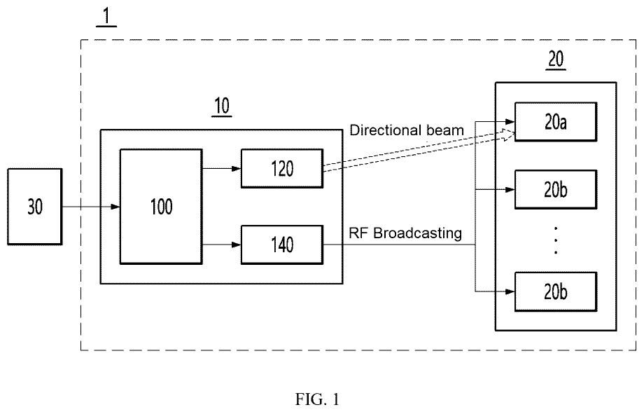

FIG. 1 is a diagram illustrating an example of a system for transmitting positioning data used to identify spatial location information of light-emitting devices.

As shown in FIG. 1, the system for transmitting positioning data 10 forms a system 1 for transmitting and receiving positioning data used to identify spatial location information together with a plurality of light-emitting devices 20 within a performance venue, and provides positioning data to enable each light-emitting device 20a, 20b to identify its spatial location information on its own.

The system for transmitting positioning data 10 includes a master console 100, a directional beam projector 120, and a positioning signal broadcaster 140.

The directional beam projector 120 projects a directional beam onto at least one light-emitting device 20a among the light-emitting devices 20a, 20b carried by each participant within the performance venue (used in the specification as “assigned to each participant,” which does not necessarily imply physical contact with the participant's body).

The directional beam transmits a trigger signal for the projection target light-emitting device 20a to use for identifying spatial location information.

For this purpose, the trigger signal is modulated into a form suitable for the properties of the directional beam. For example, when including a trigger signal in a directional infrared beam by pulse width modulating (PWM) a trigger signal, the trigger signal is first modulated into a signal having a certain pattern (pulse width). Next, the directional infrared beam is output in a blinking form that turns ON/OFF according to the pattern of the modulated trigger signal.

The trigger signal is used as a signal (trigger) that initiates the process for the light-emitting device 20a to identify its own spatial location information. The directional beam is required to have directionality (collimation) so that it is projected only to a specific area within the performance venue, and the trigger signal may be selectively provided only to the light-emitting device 20a belonging to the corresponding area. The directional beam, within the limits that satisfy these conditions, may be light (e.g., infrared), sound waves (e.g., ultrasound), or radio waves.

On the other hand, instead of a single directional beam projector 120 projecting a directional beam to all areas within the performance venue, in some cases, a combination of two or more directional beam projectors that are responsible for some areas within the performance venue may be used to project a directional beam to all areas within the performance venue.

As an example of the directional beam projector 120, a so-called “moving light” or “moving head” (hereinafter, “moving light”) equipped with a directional beam light source may be considered. Using the moving light, the directional beam light source may be moved at a desired speed across a target projection area by an actuator that is electrically/mechanically driven according to a control signal, and the size of the projection area may also be adjusted.

As another example of the directional beam projector 120, a method of controlling the directional beam light source using DLP (Digital Light Processing), LCOS (Liquid Crystal on Silicon), SLM (Spatial Light Modulator), etc. may be used.

This is specifically true when a high-power, highly directional infrared light source, such as an infrared laser, is used as the directional beam light source.

For example, the DLP (Digital Light Processing) method uses a micromirror array to control the reflection of a laser beam, so it has high compatibility with laser light sources and excellent resistance to the heat of infrared lasers.

LCOS (Liquid Crystal on Silicon) is a method of controlling a beam light source using reflective liquid crystals, and is suitable for lasers in the infrared wavelength band.

The SLM (Spatial Light Modulator) is a device that may precisely control the phase and intensity of a laser beam, so it may be used in cases where an infrared laser beam source must be controlled with high precision.

A directional beam modulated to transmit the trigger signal is projected to the light-emitting device 20a within the target projection area in synchronization with a sequence of positioning signals. Depending on the need, various methods are possible, such as sequentially scanning the entire target projection area with the directional beam, or moving the projection area while projecting the directional beam to form a specific pattern. The trigger signal is used as an important temporal and spatial reference in the spatial location calculation algorithm.

The positioning signal broadcaster 140 broadcasts a positioning signal, which is a signal modulated to include the positioning data within the performance venue, thereby simultaneously providing a single positioning data to all light-emitting devices 20a, 20b within the performance venue.

The basic concept of the positioning data has been explained earlier.

The positioning signal broadcaster 140 may be, for example, a radio frequency transmitter (RF Transmitter). More specifically, one may think of an RF transmitter in the 2.4 GHz radio frequency band used for Bluetooth, Zigbee or Wi-Fi, but as long as the condition that the radio frequency signal including the positioning data must be broadcast to all light-emitting devices within the performance venue is satisfied, the positioning signal broadcaster 140 may use radio frequency signals including the positioning data, widely including various frequency bands, various modulation methods and various communication protocols.

The master console 100 generates the positioning data based on seat map data and spatial location information for objects within the performance venue.

The spatial location information refers to information indicating the physical location that a physical object existing within the performance venue actually occupies within the actual space of the performance venue, as mentioned above.

A seat map refers to the correspondence between the seat numbers of seats in the performance venue and the actual seats in the performance venue. Therefore, the seat map data may be implemented in the form of a data table that shows the correspondence between the seat numbers of seats in the performance venue and the actual seats in the performance venue.

Additionally, the seat map may also include the correspondence between the zone numbers (e.g., the numbers assigned to each standing zone in a standing concert hall or the numbers assigned collectively to a plurality of seats in a specific area of the performance venue) of the zones within the performance venue and the zones within the performance venue. Therefore, the seat map data may also include a data table regarding the correspondence between the zone numbers and the actual zones within the performance venue.

The seat map data and the spatial location information are input from an external seat map data generator 30 connected to a system for transmitting positioning data 10. The seat map data generator 30 generates, stores, and manages seat map data and spatial location information for objects within the performance venue.

According to the embodiment, the seat map data generator 30 may be integrated as part of the system for transmitting positioning data 10 or as part of the master console 100.

Meanwhile, the positioning signal (e.g., an RF signal) modulated to include the positioning data is transmitted from the positioning signal broadcaster 140 to all light-emitting devices 20a, 20b within the performance venue.

The master console 100 controls the positioning signal to be precisely synchronized with a sequence of directional beams projected from the directional beam projector 120.

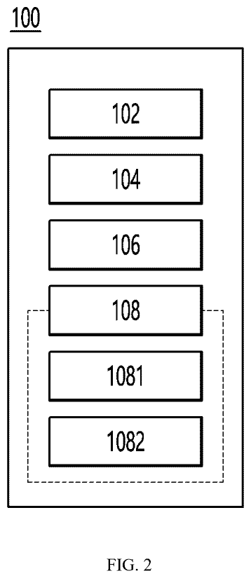

FIG. 2 is a block diagram illustrating a master console of the system for transmitting positioning data.

The embodiment of FIG. 2 exemplifies a case where a directional infrared beam light source is adopted for the directional beam projector 120 of the system for transmitting positioning data 10, and a transmitter that broadcasts a 2.4 GHz band RF radio frequency signal is adopted for the positioning signal broadcaster 140.

As shown in FIG. 2, the master console 100 includes a data manager 102, a directional beam controller 104, a positioning signal broadcaster controller 106, and an interfacer 108. The data manager 102 performs three major roles:
(1) It stores and manages seat map data for the seats in the performance venue and spatial location information for objects within the performance venue;
(2) For each sequence, it sets the positioning data that should be transmitted for that sequence. As explained earlier, the positioning data includes at least one positioning data element; and
(3) The sequence-based positioning data is transmitted to the positioning signal broadcaster controller 106 so that it may be used in generating the positioning signal broadcaster control signal. As a result, the sequence of the trigger signal transmitted via the directional beam and the sequence of the positioning data transmitted via the positioning signal are strictly synchronized.

The directional beam controller 104 performs two major roles:
(1) It generates the trigger signal and transmits it to the directional beam projector. The trigger signal is transmitted to the light-emitting device in the target projection area via the directional infrared beam, thereby enabling the light-emitting device that recognizes the directional infrared beam to initiate a process of identifying its own spatial location information; and
(2) The operation (movement direction, movement speed, projection angle, beam size, etc.) of the directional beam projector 120 is controlled so that the directional infrared beam is projected onto the target projection area within the performance venue at the planned time. When the optical system of the directional beam projector 120 includes a lens system and an aperture system, the lens system and the aperture system may be controlled to adjust the directional infrared beam projection range.

In this regard, the rotational movement of the directional beam actuator may be controlled to sequentially move the projection point of the directional infrared beam in synchronization with the sequence of positioning signals broadcast within the performance venue.

The positioning signal broadcaster controller 106 performs three major roles:
(1) It generates positioning data in each sequence, including parameters related to the directional beam;
(2) By transmitting the generated positioning data to the positioning signal broadcaster 140, it enables the positioning signal broadcaster 140 to generate the positioning signal (e.g., a radio frequency band signal) modulated to include the positioning data; and
(3) It generates a positioning signal broadcaster control signal and controls the operation of the positioning signal broadcaster 140 through this signal, ensuring that the positioning signal is broadcast to the light-emitting devices within the performance venue in synchronization with the directional infrared beam of the same sequence.

The interfacer 108 further includes an input/output interfacer 1081 and a communication interfacer 1082.

The input/output interfacer 1081 includes an input interface device (e.g., a keyboard, mouse, touchscreen, microphone, various sensor devices, etc.) that receives commands from the user for the operation of the system for transmitting positioning data 10 and the master console 100. It also includes an output interface device (e.g., a display, speaker, lamp, etc.) that indicates the operational status of the system for transmitting positioning data 10 and the master console 100.

The communication interfacer 108 is responsible for transmitting signals and data input to or output from the master console 100. For example, when seat map data and spatial location information are generated by a seat map data generator 30 outside the master console 100, they may be input into the system for transmitting positioning data 10 through the input/output interfacer 1081. In addition, the positioning data, the positioning signal broadcaster control signals, the directional beam control signals, etc. generated from the master console 100 may be transmitted to the directional beam projector 120 and the positioning signal broadcaster 140. The communication interfacer 108 may be appropriately selected from among various types of wired communication modules that perform wired communication and various types of wireless communication modules that perform wireless communication, according to the embodiment.

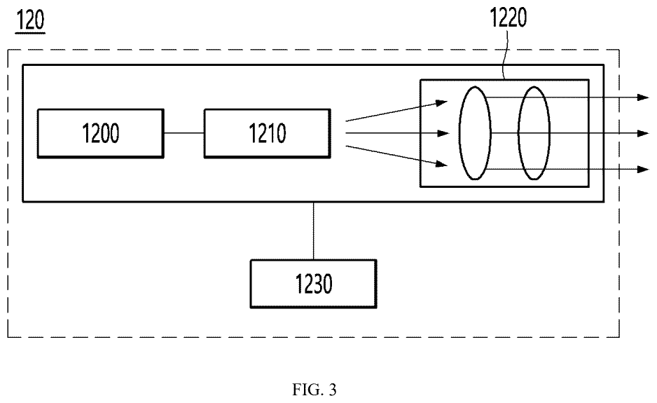

FIG. 3 is a diagram illustrating an example of a directional beam projector of the system for transmitting positioning data.

Similar to FIG. 2, FIG. 3 also illustrates a case where an infrared light source is adopted for the directional beam projector 120 of the system for transmitting positioning data 10.

The directional beam projector 120 illustrated in FIG. 3 includes a beam modulator 1200, an infrared light source 1210, an optical system 1220, and a directional beam actuator 1230.

The beam modulator 1200 modulates (e.g., PWM modulation) the directional infrared beam based on the trigger signal transmitted from the directional beam controller 104. Meanwhile, the light-emitting devices 20a, 20b that receive the directional beam demodulate the trigger signal embedded in the directional beam to initiate a process of identifying their own spatial location information.

The infrared light source 1210 generates a directional infrared beam modulated by the beam modulator 1200 based on the trigger signal.

The infrared light source 1210 is a device that generates light in the infrared wavelength band (approximately 700 nm to 1 mm).

In particular, the infrared light source used in the directional beam projector emits a directional infrared beam focused in a specific direction, and due to its characteristics of having high consistency and efficiency, the following infrared light sources may be mainly considered.

### (1) Infrared Laser Diode (IR Laser Diode)

Characteristics: Emits a high-power infrared beam at specific wavelengths (e.g., 808 nm, 980 nm, 1550 nm, etc.), and generates a highly directional and consistent light waveform.

### Applications:

Communication: Used in fiber optic networks
Military & Security: Laser rangefinders, night vision devices
Medical: Infrared-based therapeutic and surgical equipment

Advantages: Compact size, low power consumption, and high-efficiency infrared beam generation.

### (2) Infrared Light Emitting Diode (IR LED)

Characteristics: Similar to general LEDs, but emits light in the infrared band (700 nm to 1 mm), and when combined with a special lens, the beam may be focused in a specific direction.

### Applications:

Remote Control: TV and electronic device control
Sensor: Infrared distance measurement, proximity sensor
Vision Systems: Vehicle Driving Assistance Systems
Limitations: Lower directionality and output compared to laser diodes.

The optical system 1220 changes the characteristics of the directional infrared beam generated by the infrared light source 1210 so that the directional infrared beam has stronger directionality. For this purpose, the optical system 1220 is composed of a combination of lenses, mirrors, filters, etc. designed to meet the use and purpose.

For example, a collimator lens among lenses aligns the infrared beam generated from an infrared diode or infrared LED into a parallel beam. In other words, the directionality and density of the directional infrared beam generated from the infrared light source 1210 may be further enhanced as it passes through the optical system 1220.

The infrared light source 1210 and optical system 1220 determine the characteristics of the directional infrared beam, such as its size and intensity, according to the directional beam control signal.

The directional beam actuator 1230 performs the function of moving the projection area of the directional infrared beam.

The directional beam actuator 1230 may be considered a three-axis actuator driven by an electric motor. In other words, as described above, as an example of the directional beam projector 120, a so-called “moving light” or “moving head” (hereinafter, “moving light”) equipped with the infrared light source 1210 may be considered. Using the moving light, the directional beam light source may be moved at a desired speed across a target projection area by an actuator that is electrically/mechanically driven according to a control signal, and the size of the projection area may also be adjusted.

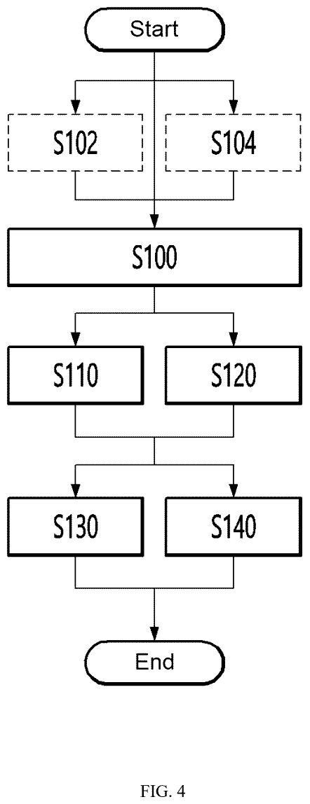

FIG. 4 is a diagram illustrating an example of a method of transmitting positioning data used to identify spatial location information of light-emitting devices within a performance venue.

As shown in FIG. 4, a method of transmitting positioning data of light-emitting devices within a performance venue, which is performed by the system for transmitting positioning data including a master console, a directional beam projector, and a positioning signal broadcaster, includes generating the positioning data (S100), generating the directional beam control signal (S110), generating the positioning signal broadcaster control signal (S120), projecting the directional beam onto the target projection area (S130), and broadcasting the positioning signal within the performance venue (S140).

In generating the positioning data (S100), the master console generates the positioning data. The positioning data is used by at least one target light-emitting device to identify its spatial location information on its own. The positioning data may be generated in each sequence based on the seat map data of the performance venue and the spatial location information of each object within the performance venue.

The seat map data generator maps information (e.g., seat numbers for specific seats, etc.) about the locations of all objects (e.g., participants, light-emitting devices assigned to the participants, master consoles, directional beam projectors, positioning signal broadcasters, etc.) within the performance venue, organized according to the performance venue layout, into spatial location information. It also generates and stores a seat map that includes the spatial location information mapped to each object within the performance venue.

If a component for generating the seat map data is embedded in the master console, generating the seat map data for the performance venue and the spatial location information for each object within the performance venue (S102) may be further performed prior to generating the positioning data (S100).

Alternatively, if the master console receives the seat map data for the performance venue and the spatial location information of each object within the performance venue from the external seat map data generator, receiving the seat map data for the performance venue and the spatial location information of each object within the performance venue from the external seat map data generator (S104) may be further performed prior to generating the positioning data (S100).

In generating the directional beam control signal (S110), the master console generates the directional beam control signal for the target projection area of the directional beam. The directional beam control signal may be generated based on directional beam projection path and beam movement time.

In one example, the master console may load the seat map and the spatial location information, and generate the positioning data based on the spatial location information.

At this time, the master console may set the movement path and the movement time for the target projection area of the directional beam on the seat map according to the layout of the performance venue. Additionally, the master console may set a sequence in which the positioning signal modulated to include the positioning data is broadcast in response to the spatial location information of each participant (i.e., the light-emitting device assigned to the participant) belonging to the movement path of the target projection area.

In generating the positioning signal broadcaster control signal (S120), the master console transmits the positioning data to the positioning signal broadcaster in each sequence and generates the positioning signal broadcaster control signal.

In projecting the directional beam onto the target projection area (S130), the directional beam projector projects the directional beam onto the target projection area based on the directional beam control signal. This step may further include generating an infrared beam that is modulated (e.g., pulse width modulated (PWM)) to include the trigger signal in the directional beam control signal. The trigger signal is used by the target light-emitting device(s) receiving it to initiate the spatial location information identification process. In addition, in projecting the directional beam onto the target projection area (S130), adjusting the optical characteristics of the infrared beam based on the directional beam control signal by the directional beam projector so that the infrared beam has directionality (not shown in the drawing) may be further included.

In projecting the directional beam onto the target projection area (S130), moving the projection area of the directional beam based on the directional beam control signal by the directional beam projector (not shown in the drawing) may be further included. For example, the directional beam actuator of the directional beam projector may be configured to move the projection area of the directional beam based on the directional beam control signal. The target projection area projected by the directional beam projector may be configured to move along a freely set path on a coordinate system mapped to the performance venue.

In broadcasting the positioning signal within the performance venue (S140), the positioning signal broadcaster broadcasts the positioning signal within the performance venue so as to be transmitted in a sequence synchronized with the directional beam based on the positioning signal broadcaster control signal. At this step, the positioning signal broadcast in synchronization with the directional beam in a specific sequence may include positioning data elements regarding the direction of movement of the directional beam in the sequence and positioning data elements regarding the time of movement of the directional beam.

The method for the light-emitting device to identify its own spatial location information, i.e. the spatial location calculation algorithm, may be designed in various ways. At this time, the positioning data elements that must be included in the positioning data may vary according to the spatial location calculation algorithm.

For example, the following may be considered as spatial location calculation algorithms.

### Spatial Location Calculation Algorithms

Algorithm 1) A technique for receiving spatial location information for a specific object and identifying the spatial location information by comparing times of reception.

Algorithm 2) A technique for identifying spatial location information by receiving spatial location information of a directional beam projector and projection angle data of a directional beam projector and performing a trigonometric function-based computation on these positioning data elements.

Algorithm 3) A technique for identifying spatial location information by receiving directional beam projection distance and projection angle data from a directional beam projector and performing a trigonometric function-based computation on these positioning data elements.

The positioning data elements that are absolutely necessary for positioning data in each of these three spatial location calculation algorithms are summarized in Table 3 below.

TABLE 3

| Spatial | |
|---|---|
| location | |
| calculation | |
| algorithms | Positioning data elements |
| Algorithm 1) | Spatial location information of a specific object |
| Algorithm 2) | Spatial location information of directional beam projector, |
| | Projection angle data of directional beam projector |
| Algorithm 3) | Directional beam projection distance of directional beam |
| | projector, |
| | Projection angle data of directional beam projector |

In addition to the three spatial location calculation algorithms described above, there may be various algorithms that utilize positioning data elements to enable a light-emitting device to identify its own spatial location information.

For example, the spatial location calculation algorithm may be programmed to be included in a program for identifying spatial location information and then embedded in the memory of each light-emitting device.

The timing at which the program(s) for identifying spatial location information, which implement the spatial location calculation algorithm, are embedded in the memory of each light-emitting device is generally before the performance. However, it is also possible for the program to be downloaded in real time during the performance, such as through OTA (On-The-Air) method, etc., and then stored in the memory of each light-emitting device.

In this way, if each light-emitting device identifies its spatial location information on its own, the central control system for performance production may individually or as a group control the light-emitting status of each light-emitting device based on the spatial location information of each light-emitting device, thereby implementing various lighting effects within the performance venue. For example, by utilizing a technique such as that exemplified in Korean Patent Application No. 10-2024-0068851 by the inventor of the present disclosure, various lighting effects may be implemented in real time within a performance venue.

In particular, by utilizing the present disclosure, unique effects such as the ability to quickly and accurately determine spatial location information of large-scale light-emitting devices “without intervention by participants” and the ability to update spatial location information of each light-emitting device in real time during a performance, thereby enabling dynamic performance production, may be expected.

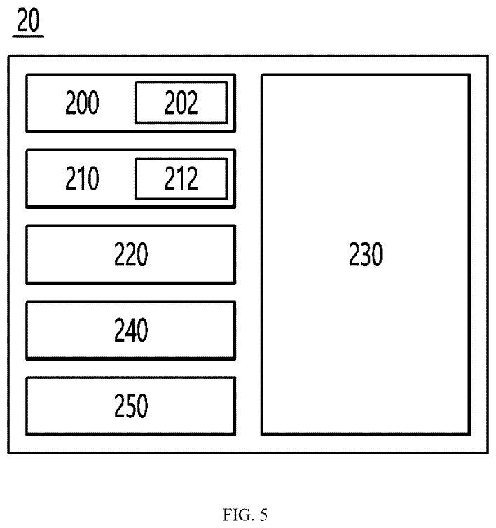

FIG. 5 is a diagram illustrating an example of a light-emitting device.

As illustrated in FIG. 5, the light-emitting device 20 includes an IR receiver 200, an RF receiver 210, a memory 220, a processor 230, a light-emitter 240, and a power supply 250.

The light-emitting device 20 is an electrically powered light-emitting device carried by the audience at the performance venue. The light-emitting device 20 may be implemented in various forms, such as an LED cheer stick or LED wristband.

The light-emitting device 20 may perform various performance productions by changing the light-emitting state according to the control of the central control system for performance production. The central control system for performance production may be integrated into the system for transmitting positioning data 10 or, in some cases, may be implemented as a separate control system that is wirelessly or wiredly connected to the system for transmitting positioning data 10.

The light-emitting device 20 receives the positioning signal (e.g., an RF signal) and the directional beam (e.g., a directional infrared beam) transmitted from the system for transmitting positioning data 10, demodulates the positioning signal and the directional beam to extract the positioning data and the trigger signal, respectively, and then identifies its own spatial location information according to the spatial location calculation algorithm based on the positioning data and the trigger signal.

In the embodiment of FIG. 5, a light-emitting device is described in which a 2.4 GHz band RF signal is used as the positioning signal and a directional infrared beam is used as the directional beam.

The IR receiver 200 recognizes the directional infrared beam projected by the directional beam projector 120. For example, an infrared sensor may be used as the IR receiver 200.

The IR receiver 200 further includes an IR demodulator 202. The IR demodulator 202 demodulates the infrared beam and extracts the trigger signal according to a control program stored in the processor 230 and memory 220.

The RF receiver 210 receives the positioning signal broadcast within the performance venue. As the RF receiver 210, a receiver for Zigbee communication, which receives RF signals in the 2.4 GHz band, may be used, for example. However, using the receiver for Zigbee communication does not mean that the communication protocol must also use the Zigbee communication protocol.

The RF receiver 210 further includes an RF demodulator 212. The RF demodulator demodulates the positioning signal according to the control program stored in the processor 230 and memory 220 and extracts the positioning data in each sequence.

The memory 220 stores the control program, spatial location calculation algorithm, performance production data, etc. Further, the memory 220 may store the positioning data. In addition, the memory 220 may temporarily store data for computations performed according to the spatial location calculation algorithm. Various forms and types of memory that may be used for this purpose are widely utilized in the memory 220.

The processor 230 controls the IR receiver 200, RF receiver 210, IR demodulator 202, RF demodulator 212, and light-emitter 240 according to the control program stored in the memory 220. Additionally, the processor 230 identifies the spatial location information of the light-emitting device 20 using the spatial location calculation algorithm, the trigger signal, and the positioning data. In addition, by controlling the blinking state (lighting, turning off, brightness, duration, etc.) of the light-emitter 240 according to the performance production data, the intended performance production effect may be obtained within the performance venue.

The light-emitter 240 operates to achieve the blinking state (e.g., lighting, turning off, brightness, duration, etc.) as controlled by the processor 230. The light-emitter 240 may use a light-emitting diode (LED), but various lighting elements and lighting devices that may be used for the purpose of obtaining a performance production effect may be widely utilized.

The power supply 250 supplies power to the light-emitting device 20. Since it is often implemented in the form of an LED cheer stick or an LED wristband carried by the audience, a rechargeable battery and its charging control circuit may be used as the power supply 250. However, various power supply means (batteries, wired AC power supplies, small generators, etc.) that may be used for the purpose of supplying power to the light-emitting device 20 may be widely used.

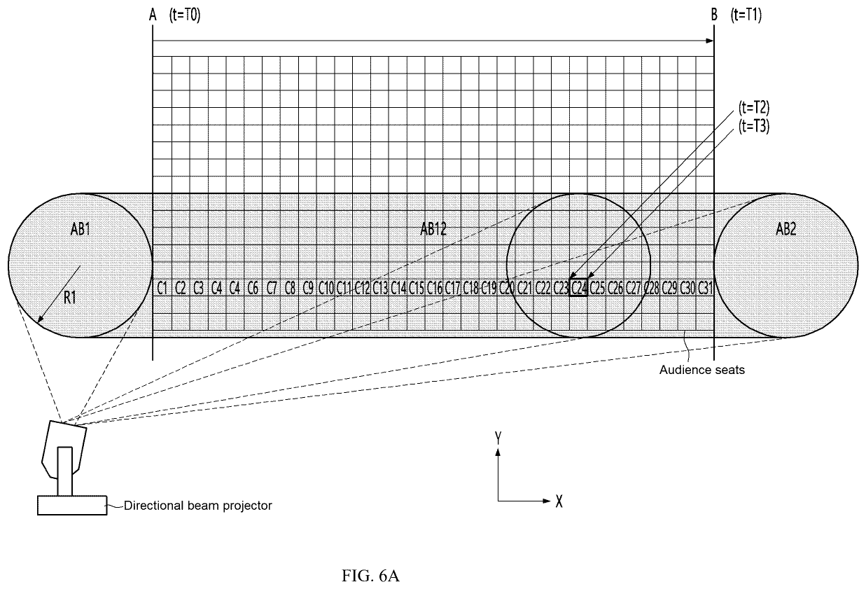

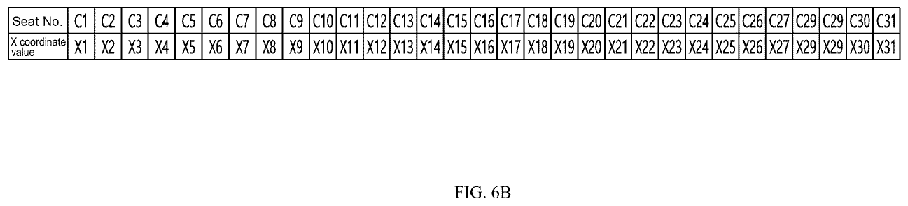

FIGS. 6A and 6B are diagrams illustrating a first algorithm, which is a spatial location calculation algorithm for a technique in which a light-emitting device within a performance venue receives spatial location information of a specific object and identifies the spatial location information by comparing times of reception.

According to the content of the spatial location calculation algorithm used by the light-emitting device, one or more positioning data elements that must be included in the positioning data are specifically specified so that the master console may cause at least one target light-emitting device to identify its own spatial location information.

In order for the light-emitting device in the performance venue to identify the spatial location information according to the first algorithm, “the spatial location information of the specific object” must be included as the positioning data element, as shown in Table 2.

To this end, the system for transmitting positioning data broadcasts the positioning signal, which includes the spatial location information of the specific object as the positioning data element, to the light-emitting devices within the performance venue through the following specific process.

### Step 1.

The seat map data generator maps the location information (which may include seat numbers, etc.) of all objects (individual seats, master consoles, directional beam projectors, positioning signal broadcasters, and other objects with fixed locations) within the performance venue, configured according to the performance venue layout, to coordinate values in the coordinate system used by the seat map data generator.

The seat map generated by the seat map data generator includes the location information and corresponding coordinate values of all objects within the performance venue. In some cases, the seat map may further include information about the type of coordinate system used in the seat map (e.g., planar Cartesian coordinate system, spatial Cartesian coordinate system, planar polar coordinate system, spatial polar coordinate system, etc.).

FIG. 6A is a diagram illustrating a case where the seat map is generated using an XY-plane Cartesian coordinate system, particularly with the X-axis (horizontal axis) and Y-axis (vertical axis).

### Step 2.

The master console loads system data and spatial location information of all objects within the performance venue into the data manager, generated by the seat map data generator (which may be an external device or a component integrated into the master console).

### Step 3.

According to the layout of the performance venue, the master console respectively inputs the X-axis and Y-axis movement paths and movement times of the target projection area of the directional beam projector on the seat map.

### Step 4.

The master console sets the range and sequence of coordinate values broadcast from the positioning signal broadcaster in response to the location of each object (e.g., seat) belonging to the movement path of the target projection area of the directional beam projector.

The target projection area of the directional beam projector may, for example, move in the X-axis direction and the Y-axis direction, respectively.

(1) In the case of X-axis coordinate transmission, the directional beam projector projects the directional beam while moving its trajectory along the X-axis path in the left-right direction, according to the control of the master console. At the same time, the positioning signal broadcaster sequentially broadcasts the coordinate value sequence of the X-axis at fixed time intervals, synchronized with the trajectory movement of the directional beam. A light-emitting device included in the trajectory of the directional beam detects the directional infrared beam with the IR receiver and the positioning signal with the RF receiver, and then demodulates the trigger signal and the positioning data at a recognized point in time to apply the spatial location calculation algorithm to identify its own X-axis coordinate value. The identified X-axis coordinate value is stored in the memory of the light-emitting device.

(2) In the case of Y-axis coordinate transmission, the directional beam projector projects the directional beam while moving its trajectory along the Y-axis path in the up-down direction, according to the control of the master console. At the same time, the positioning signal broadcaster sequentially broadcasts the coordinate value sequence of the Y-axis at fixed time intervals, synchronized with the trajectory movement of the directional beam. A light-emitting device included in the trajectory of the directional beam detects the directional infrared beam with the IR receiver and the positioning signal with the RF receiver, and then demodulates the trigger signal and the positioning data at a recognized point in time to apply the spatial location calculation algorithm to identify its own Y-axis coordinate value. The identified Y-axis coordinate value is stored in the memory of the light-emitting device.

For example, the directional beam projectors may be installed and used in one or more performance venues as needed to cover the entire target projection area according to the size, structure, and layout of the performance venue. When two or more directional beam projectors are used, the X-axis and Y-axis coordinate data transmission may divide the target projection area into a plurality of zones according to the size, structure, and layout of the performance venue, and each directional beam projector in charge of each zone may project the directional beam within that zone.

FIG. 6A illustrates a case where the directional beam projector projects the directional infrared beam while moving the trajectory of the directional beam in the A to B direction of the X-axis for a certain time period (T1-T0).

The circularly shaded areas AB1, AB2 represent the target projection areas of the directional beam, each with a radius R1. During the certain time period (T1-T0), the directional beam moves along a trajectory with the target projection areas set as area AB1, area AB2, and the intermediate area AB12.

For convenience, the time when the rightmost point of the projection area of the directional beam is at point A is referred to as T0, and the time when the leftmost point of the directional beam is at point B is referred to as T1.

FIG. 6B is a diagram illustrating an example of the sequence of X-axis coordinate values.

The data sequence exemplified in FIG. 6B is the sequence of X-axis coordinate values to be assigned to objects within the target projection area trajectory from time T0 to time T1. This data sequence, i.e., the positioning data elements, includes the corresponding X-axis coordinate values for each seat number on the seat map.

Referring to FIG. 6A, in an embodiment where X-axis coordinate values are transmitted to the light-emitting devices located at the seats C1 to C31 in Row C, the following conditions may be considered to explain the specific method of calculating the X-axis coordinate values.

Distance between A and B: 1,550 cm
Interval between seats: 50 cm
Total number of seats: 31 (C1~C31)
Diameter of directional infrared beam (2 × R1): 200 cm
Modulation frequency of directional infrared beam: 38 kHz
Movement time (T1 − T0) of the rightmost end point of the directional
infrared beam's projection area starting from point A and reaching the
leftmost end point at point B: 30 seconds
Data sequence of X-axis coordinate values broadcasted during the
movement time (T1 − T0): FIG. 6B

For example, the process by which the light-emitting device of the seat C24 identifies its own X-axis coordinate value according to the first algorithm is as follows.

### Step 1

(1) When the diameter of the directional infrared beam of the target projection area is 200 cm, the number of seats per projection range is 4.

(2) When the directional infrared beam moves along the trajectory according to the above conditions, the directional infrared beam projection time assigned to each seat is 0.97 seconds on average (30 seconds/31 seats). Therefore, the seat C24 receives the beam for approximately 3.88 seconds (0.97 seconds×4).

(3) At this time, when the light-emitting device of the seat C24 demodulates the received positioning signal, it becomes the positioning data that includes X-axis coordinate values (X23, X24, X25, X26) as the positioning data elements. The light-emitting device of the seat C24 may determine its own coordinate value as the coordinate value X24 of the sequence corresponding to the midpoint time ((T3-T2)/2) between the time T2 when the directional infrared beam is first detected and the time T3 when it is last detected. However, a modified embodiment is also possible in which the coordinate value of the sequence corresponding to a different time instead of the midpoint time is determined as its own coordinate value. For example, the midpoint or average value of the X-axis coordinate value data sequence received in synchronization with the directional infrared beam may be close to the actual spatial location information. Therefore, various computational methods for calculating values close to the actual spatial location information may be widely used.

The method of obtaining the Y-axis coordinate value according to the first algorithm may be performed in the same manner as the method of obtaining the X-axis coordinate value.

Through this process, the light-emitting device of the seat C24 may identify its own spatial location information as a pair of X-axis and Y-axis coordinate values in the XY-plane Cartesian coordinate system using the first algorithm.

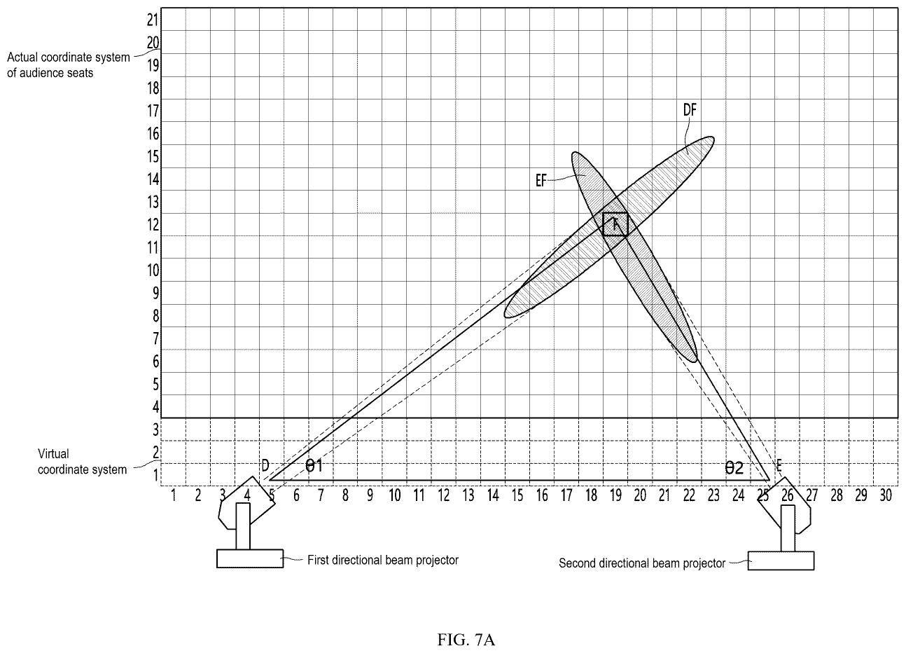

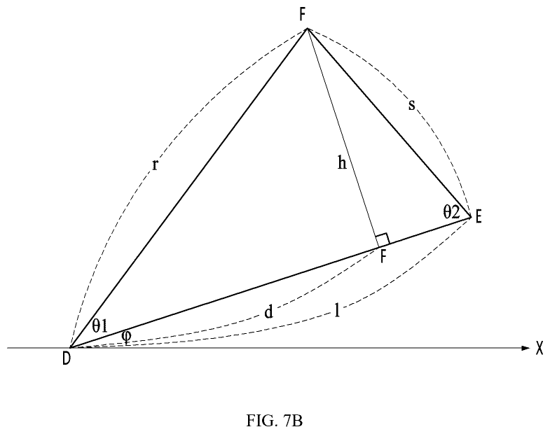

FIGS. 7A and 7B are diagrams illustrating a second algorithm, which is a spatial location calculation algorithm for a technique in which a light-emitting device receives spatial location information and projection angle data of a directional beam projector and identifies spatial location information by performing a trigonometric function-based computation on these positioning data elements.

According to the second algorithm, for the light-emitting device within the performance venue to identify the spatial location information, “the spatial location information and the projection angles of two directional beam projectors” must be included as the positioning data elements, as shown in Table 2.

At this time, the two directional beam projectors each project the directional infrared beam onto the same light-emitting device. The timing of beam projection onto the same light-emitting device does not need to be identical.

To this end, the system for transmitting positioning data broadcasts positioning signals, which include spatial location information (first spatial location information) and projection angle (first projection angle) of a first directional beam projector and spatial location information (second spatial location information) and projection angle (second projection angle) of a second directional beam projector as positioning data elements, to light-emitting devices within a performance venue through the following specific process for two directional beam projectors.

### Step 1.

The seat map data generator maps the location information (which may include seat numbers, etc.) of all objects (individual seats, master consoles, directional beam projectors, positioning signal broadcasters, and other objects with fixed locations) within the performance venue, configured according to the performance venue layout, to coordinate values in the coordinate system used by the seat map data generator.

The seat map generated by the seat map data generator includes the location information and corresponding coordinate values of all objects within the performance venue. In some cases, the seat map may further include information about the type of coordinate system used in the seat map (e.g., planar Cartesian coordinate system, spatial Cartesian coordinate system, planar polar coordinate system, spatial polar coordinate system, etc.).

FIG. 7A is a diagram illustrating a case where the seat map is generated using an XY-plane Cartesian coordinate system, particularly with an X-axis (horizontal axis) and a Y-axis (vertical axis).

### Step 2.

The master console loads system data and spatial location information of all objects within the performance venue into the data manager, generated by the seat map data generator (which may be an external device or a component integrated into the master console).

### Step 3.

According to the layout of the performance venue, the master console respectively inputs the X-axis and Y-axis movement paths and movement times of the target projection area of the two directional beam projectors on the seat map.

### Step 4.

The master console sets a data sequence that includes [the coordinate values of the first directional infrared beam projector, the coordinate values of the second directional infrared beam projector, the first projection angle, and the second projection angle] in response to the location of each object (e.g., seat) belonging to the movement path of the target projection area of the two directional beam projectors.

In the embodiment of FIG. 7A, the target projection area of the first directional beam projector may move, for example, from left to right on the X-axis, and the target projection area of the second directional beam projector may move in the opposite direction, for example, from right to left on the X-axis.

(1) In the case of X-axis coordinate transmission, the first directional beam projector projects the directional beam while moving its trajectory along the X-axis path in the left-right direction, according to the control of the master console. The second directional beam projector projects the directional beam while moving its trajectory along the X-axis path in the right-left direction.

(2) At the same time, the positioning signal broadcaster sequentially broadcasts a positioning signal sequence, which includes [the coordinate values of the first directional infrared beam projector, the coordinate values of the second directional infrared beam projector, the first projection angle, and the second projection angle], synchronized with the trajectory movement of the directional beam. A light-emitting device included in the trajectory of a directional beam detects the directional infrared beam with the IR receiver and the positioning signal with the RF receiver, and then demodulates the trigger signal and the positioning data at a recognized point in time to apply the spatial location calculation algorithm. Therefore, when the beam of the first directional beam projector is detected, the coordinate values and the first projection angle of the first directional beam projector may be identified. Additionally, when the beam of the second directional beam projector is detected, the coordinate values and the second projection angle of the second directional beam projector may be identified. The coordinate values of the identified first directional beam projector, the coordinate values of the second directional beam projector, the first projection angle, and the second projection angle are stored in the memory of the light-emitting device.

FIG. 7A is a diagram illustrating a case where the first directional beam projector disposed to have coordinate values (x1, y1) at a point D within a performance venue projects a directional infrared beam at a projection angle θ1, and the second directional beam projector disposed to have coordinate values (x2, y2) at a point E projects a directional infrared beam at a projection angle θ2.

The shaded area DF represents the trajectory of the target projection area of the first directional beam projector, and the area EF represents the trajectory of the target projection area of the second directional beam projector. Point F is the common area of area DF and area EF.

For example, the process by which a light-emitting device of a seat disposed at point F according to the second algorithm identifies its own spatial location information (coordinate values on the XY-plane Cartesian coordinate system) is as follows.

### Step 1

(1) The light-emitting device disposed at point F stores the coordinate values of the first directional beam projector, the coordinate values of the second directional beam projector, the first projection angle, and the second projection angle in the memory as described above.

(2) As shown in FIG. 7A, when points D, E, and F are connected with an imaginary line, a triangle DEF is created. At this time, the interior angle of the vertex D becomes the first projection angle θ1, and the interior angle of the vertex E becomes the second projection angle θ2. Therefore, using the given data values and trigonometric functions, the coordinates of point F, i.e., the coordinates of the light-emitting device disposed at point F, may be obtained using trigonometric functions.

FIG. 7B is a diagram for explaining a method of obtaining the coordinates of the light-emitting device from triangle DEF.

The memory of the light-emitting device stores positioning data elements as shown in Table 4.

TABLE 4

| | Positioning |
|---|---|
| Contents of the positioning data elements | data elements |
| Coordinates of first directional beam projector, | (x1, y1) |
| In other words, coordinates of point D | |
| Coordinates of second directional beam projector, | (x2, y2) |
| In other words, coordinates of point E | |
| Projection angle of first directional beam projector, | θ1 |
| In other words, interior angle of vertex D | |
| Projection angle of second directional beam | θ2 |
| projector, | |
| In other words, interior angle of vertex E | |

The distance 1 between points D and E is obtained by mathematical equation 1.

$$l = \sqrt{{( {x}_{2} - {x}_{1} )}^{2} + {( {y}_{2} - {y}_{1} )}^{2}} . \qquad [ Mathematical equation 1 ]$$

If the distance between point D and point F and the distance between point E and point F are r and s, respectively, the distance r is obtained by Mathematical equation 2.

$$l = DF + F E = r \cdot cos ( θ1 ) + s \cdot cos ( θ2 ) , \qquad [ Mathematical equation 2 ]$$

$$r = ( 1 - s \cdot cos ( θ 2 ) ) / cos ( θ1 ) .$$

When the line segment connecting point D and point E is perpendicular to the line segment connecting point F and point G, the distance h between point F and point G is obtained by Mathematical equation 3.

$$h = r \cdot sin ( θ1 ) = s \cdot sin ( θ2 ) , \qquad [ Mathematical equation 3 ]$$

$$r = s \cdot sin ( θ2 ) / sin ( 01 ) .$$

Using Mathematical equations 2 and 3, the distance s is obtained by Mathematical equation 4.

$$r = ( 1 - s \cdot cos ( θ2 ) ) / cos ( θ1 ) = s \cdot sin ( θ2 ) / sin ( θ1 ) , therefore , \qquad [ Mathematical equation 4 ]$$

$$s = 1 sin ( θ1 ) / sin ( θ2 + θ2 ) .$$

The angle (φ) between the straight line connecting point D and point E and the X-axis is obtained by Mathematical equation 5 using the coordinates (x1, y1) of point D and the coordinates (x2, y2) of point E.

$$tan φ = \frac{{y}_{2} - {y}_{1}}{{x}_{2} - {x}_{1}} , \qquad [ Mathematical Formula 5 ]$$

$$φ = {tan}^{- 1} ( \frac{{y}_{2} - {y}_{1}}{{x}_{2} - {x}_{1}} ) .$$

Therefore, the coordinates (x3, y3) of the light-emitting device disposed at point F are obtained by Mathematical equation 6.

$${x}_{3} = {x}_{1} + r cos ( {θ}_{1} + φ ) , \qquad [ Mathematical equation 6 ]$$

$${y}_{3} = {y}_{1} + r sin ( {θ}_{1} + φ ) , therefore ,$$

$$( {x}_{1} , {y}_{3} ) = ( ( {x}_{1} + r cos ( {θ}_{1} + φ ) , ( {y}_{1} + r sin ( {θ}_{1} + φ ) ) .$$

For example, when the audience seats in FIG. 7A correspond to the XY-plane Cartesian coordinate system of the same scale, if the coordinates of the point D where the first directional beam projector is disposed is (5, 1) and the first projection angle is 40.3 degrees, and the coordinates of the point E where the second directional beam projector is disposed is (25, 1) and the second projection angle is 61.9 degrees, the coordinate values of the seat and light-emitting device disposed at the point F become (18.81, 12.68). Therefore, the light-emitting device at point F may be identified as having its own spatial location information (i.e., coordinate values in the XY-plane Cartesian coordinate system) as (19, 13).

In the embodiment of FIG. 7A, a case is described where a planar Cartesian coordinate system with the same scale for the X-axis and Y-axis is used in the seat map. However, depending on the performance venue, a coordinate system may be generated using an XY-plane Cartesian coordinate system with different scales for the X-axis and Y-axis to suit the performance venue, taking into account factors such as seat interval in three-dimensional space.

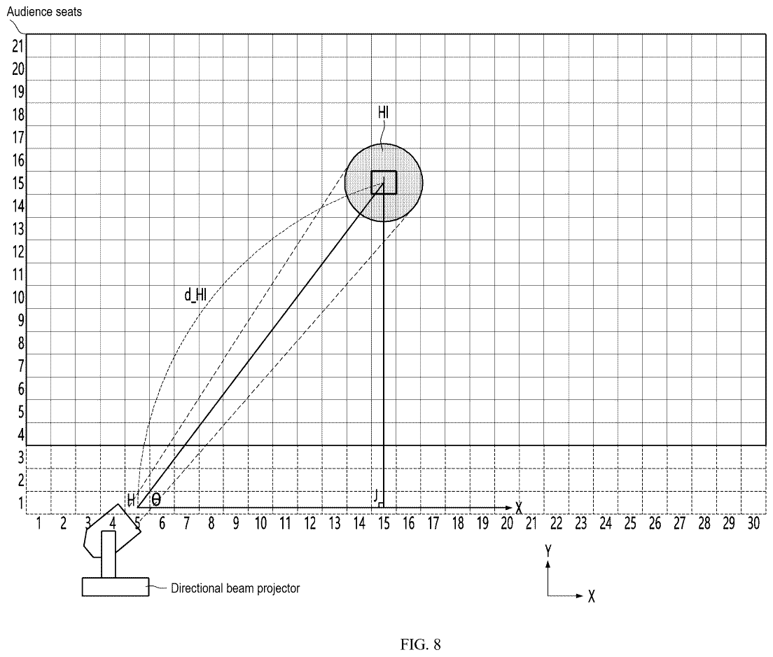

FIG. 8 is a diagram illustrating a third algorithm, which is a spatial location calculation algorithm for a technique in which a light-emitting device receives directional beam projection distance and projection angle data from a directional beam projector and identifies spatial location information by performing a trigonometric function-based computation on these positioning data elements.

In order for the light-emitting device in the performance venue to identify the spatial location information according to the third algorithm, “the directional beam projection distance of the directional beam projector and the projection angle of the directional beam projector” must be included as the positioning data element, as shown in Table 2.

To this end, the system for transmitting positioning data broadcasts the positioning signal, which includes the directional beam projection distance (i.e., the distance between the directional beam projector and the target projection area) at the time of directional beam projection and the projection angle as the positioning data elements, to the light-emitting devices within the performance venue through the following specific process for the directional beam projector.

### Step 1.

The seat map data generator maps the location information (which may include seat numbers, etc.) of all objects (individual seats, master consoles, directional beam projectors, positioning signal broadcasters, and other objects with fixed locations) within the performance venue, configured according to the performance venue layout, to coordinate values in the coordinate system used by the seat map data generator.

The seat map generated by the seat map data generator includes the location information and corresponding coordinate values of all objects within the performance venue. In some cases, the seat map may further include information about the type of coordinate system used in the seat map (e.g., planar Cartesian coordinate system, spatial Cartesian coordinate system, planar polar coordinate system, spatial polar coordinate system, etc.).

FIG. 8 is a diagram illustrating a case where the seat map is generated using an XY-plane Cartesian coordinate system, particularly with the X-axis (horizontal axis) and Y-axis (vertical axis).

### Step 2.

The master console loads system data and spatial location information of all objects within the performance venue into the data manager, generated by the seat map data generator (which may be an external device or a component integrated into the master console).

### Step 3.

According to the layout of the performance venue, the master console respectively inputs the X-axis or Y-axis movement paths and movement times of the target projection area of the directional beam projector on the seat map.

### Step 4.

The master console sets a data sequence including [the distance between the directional beam projector and the target projection area at the time of directional beam projection, and the projection angle] in response to the location of each object (e.g., seat) belonging to the movement path of the target projection area of the directional beam projector.

(1) As illustrated in FIG. 8, the trajectory of the directional infrared beam may move along the Y-axis path in the up-down direction or along the X-axis path in the left-right direction according to the control of the master console.

(2) At the same time, the positioning signal broadcaster sequentially broadcasts a positioning signal sequence, which includes [the distance between the directional beam projector and the target projection area at the time of directional beam projection, and the projection angle], synchronized with the trajectory movement of the directional beam. A light-emitting device included in the trajectory of the directional beam detects the directional infrared beam with the IR receiver and the positioning signal with the RF receiver, and then demodulates the trigger signal and the positioning data at a recognized point in time to apply the spatial location calculation algorithm. Therefore, when the beam of the directional beam projector is detected, the distance to the directional beam projector at the time of directional beam projection and the beam projection angle may be identified. The identified positioning data elements are stored in the memory of the light-emitting device.

FIG. 8 is a diagram illustrating a case where a directional beam projector disposed at a point H in a performance venue projects a directional infrared beam at a point I with a projection angle θ, and the distance between the points H and I is d_HI.

The shaded area HI represents the target projection area of the directional beam projector.

For example, the process by which a light-emitting device of a seat disposed at point I according to the third algorithm identifies its own spatial location information (coordinate values on the XY-plane Cartesian coordinate system) is as follows.

### Step 1

(1) The light-emitting device disposed at point I stores the distance d_HI between the directional beam projector and the target projection area at the time of directional beam projection and the projection angle θ in the memory as described above.

(2) When the point J is the intersection of the X-axis and the straight line drawn so that point I is perpendicular to the X-axis, as shown in FIG. 8B, if point H, point I, and point J are connected by an imaginary line, a triangle HIJ is created. The triangle HIJ has an internal angle of vertex H that is the projection angle θ, and a distance between point H and point I is the distance d_HI.

At this time, if point H is defined as the origin, the coordinates of point H become (0,0), so the coordinates (x4, y4) of point I are obtained by Mathematical equation 7.

$$( x 4 , y 4 ) = ( d\_HI \cdot cos θ , d\_HI \cdot sin θ ) . \qquad [ Mathematical equation 7 ]$$

What is claimed is:

1. A system for transmitting positioning data used to identify spatial location information of light-emitting devices within a performance venue in a system for transmitting and receiving positioning data comprising the system for transmitting positioning data and a plurality of light-emitting devices, the system comprising:
a master console configured to generate positioning data to enable each of the plurality of light-emitting devices to identify its spatial location information on its own;
a directional beam projector configured to project a directional beam onto at least one target light-emitting device to identify its spatial location information among the plurality of light-emitting devices; and
a positioning signal broadcaster configured to broadcast a positioning signal modulated to include the positioning data to the plurality of light-emitting devices within the performance venue.

2. The system for transmitting positioning data used to identify spatial location information of light-emitting devices according to claim 1, wherein the master console further comprises:
a data manager configured to generate and store the positioning data for the at least one target light-emitting device in each sequence based on seat map data of the performance venue and spatial location information of each object within the performance venue;
a directional beam controller configured to generate a directional beam control signal to control an operation of the directional beam projector; and
a positioning signal broadcaster controller configured to generate a positioning signal broadcaster control signal to control the positioning signal broadcaster.

3. The system for transmitting positioning data used to identify spatial location information of light-emitting devices according to claim 2, wherein the object comprises at least individual seats disposed in the performance venue, the directional beam projector, and the positioning signal broadcaster.

4. The system for transmitting positioning data used to identify spatial location information of light-emitting devices according to claim 2, wherein the directional beam controller is configured to transmit a trigger signal to initiate a spatial location information identification process of the target light-emitting device to the directional beam projector.

5. The system for transmitting positioning data used to identify spatial location information of light-emitting devices according to claim 2, wherein the positioning signal broadcaster controller is configured to transmit the positioning data to the positioning signal broadcaster in each sequence and control the positioning signal to be transmitted in a sequence synchronized with the directional beam.

6. The system for transmitting positioning data used to identify spatial location information of light-emitting devices according to claim 1, wherein the positioning signal is a radio frequency signal.

7. The system for transmitting positioning data used to identify spatial location information of light-emitting devices according to claim 1, wherein the directional beam projector further comprises:
a beam modulator configured to modulate a directional beam based on a trigger signal transmitted from a directional beam controller;
a light source configured to emit the directional beam modulated by the beam modulator based on the trigger signal; and
an optical system configured to adjust optical characteristics of the directional beam emitted by the light source.

8. The system for transmitting positioning data used to identify spatial location information of light-emitting devices according to claim 7, wherein the directional beam projector further comprises a communication interface configured to receive the trigger signal, a directional beam modulation signal, and a directional beam control signal from the master console.

9. The system for transmitting positioning data used to identify spatial location information of light-emitting devices according to claim 7, wherein the directional beam projector further comprises a directional beam actuator configured to move a projection area of the directional beam.

10. The system for transmitting positioning data used to identify spatial location information of light-emitting devices according to claim 1, wherein the directional beam is a directional infrared beam.

11. The system for transmitting positioning data used to identify spatial location information of light-emitting devices according to claim 1, wherein the positioning data comprises, as positioning data elements constituting the positioning data, at least one of spatial location information of the directional beam projector, a projection angle of the directional beam, a beam projection distance from the directional beam to the target light-emitting device, an intensity of the directional beam, an arrival time of the directional beam, and a unique identification value of the directional beam projector.

12. The system for transmitting positioning data used to identify spatial location information of light-emitting devices according to claim 1, wherein the positioning data comprises at least one positioning data element in a specific sequence.

13. A method of transmitting positioning data used to identify spatial location information of light-emitting devices within a performance venue in a system for transmitting positioning data comprising a master console, a directional beam projector, and a positioning signal broadcaster, the method comprising:
generating positioning data to enable at least one target light-emitting device to identify its spatial location information on its own by the master console;
generating a directional beam control signal for a target projection area of a directional beam by the master console;
transmitting the positioning data to the positioning signal broadcaster in each sequence and generating a positioning signal broadcaster control signal to control the positioning signal broadcaster by the master console;
projecting the directional beam onto the target projection area based on the directional beam control signal by the directional beam projector; and
by the positioning signal broadcaster, generating a positioning signal modulated to include the positioning data, and broadcasting the positioning signal within the performance venue to be transmitted in a sequence synchronized with the directional beam, based on the positioning signal broadcaster control signal.

14. The method of transmitting positioning data used to identify spatial location information of light-emitting devices according to claim 13, wherein the positioning data is generated in each sequence based on seat map data of the performance venue and spatial location information of each object within the performance venue.

15. The method of transmitting positioning data used to identify spatial location information of light-emitting devices according to claim 13, wherein the projecting of the directional beam onto the target projection area further comprises:
generating, by the directional beam projector, a modulated infrared beam including a trigger signal for initiating spatial location information identification of the target light-emitting device based on the directional beam control signal; and
adjusting optical characteristics of the infrared beam by the directional beam projector, based on the directional beam control signal, so that the infrared beam has directionality.

16. The method of transmitting positioning data used to identify spatial location information of light-emitting devices according to claim 13, wherein the projecting of the directional beam onto the target projection area further comprises moving a projection area of the directional beam by the directional beam projector, based on the directional beam control signal.

17. The method of transmitting positioning data used to identify spatial location information of light-emitting devices according to claim 13, wherein, in generating the positioning data to enable the at least one target light-emitting device to identify its spatial location information on its own by the master console,
if a spatial location calculation algorithm of the light-emitting device identifies spatial location information by receiving spatial location information of a specific object and comparing times of reception, the positioning data comprises the spatial location information of the specific object as a positioning data element.

18. The method of transmitting positioning data used to identify spatial location information of light-emitting devices according to claim 13, wherein, in generating the positioning data to enable the at least one target light-emitting device to identify its spatial location information on its own by the master console,
if a spatial location calculation algorithm of the light-emitting device identifies spatial location information by performing a trigonometric function-based computation on spatial location information and projection angle data of two directional beam projectors, the positioning data comprises first spatial location information and a first projection angle of a first directional beam projector, and second spatial location information and a second projection angle of a second directional beam projector as positioning data elements.

19. The method of transmitting positioning data used to identify spatial location information of light-emitting devices according to claim 13, wherein, in generating the positioning data to enable the at least one target light-emitting device to identify its spatial location information on its own by the master console,
if a spatial location calculation algorithm of the light-emitting device identifies spatial location information by performing a trigonometric function-based computation on a directional beam projection distance and a projection angle data from the directional beam projector, the positioning data comprises a distance between the directional beam projector and the light-emitting device and a projection angle of the directional beam projector as positioning data elements.
